(19) United States
(12) Patent Application Publication
(10) Pub. No.: US 2015/0076409 A1
(43) Pub. Date: Mar. 19, 2015

(54) Metabolic Simulator Having a Catalytic Engine

(71) Applicant: INGMAR MEDICAL, LTD., Pittsburgh, PA (US)

(72) Inventor: Stefan Frembgen, Pittsburgh, PA (US)

(21) Appl. No.: 14/488,328

(22) Filed: Sep. 17, 2014

Related U.S. Application Data
(60) Provisional application No. 61/879,478, filed on Sep. 18, 2013.

(51) Int. Cl. B01J 7/00; C01B 31/20

(52) U.S. Cl. CPC B01J 7/00; C01B 31/20
USPC 252/372; 422/600; 422/105

(57) ABSTRACT

A respiratory metabolic simulator is disclosed. The respiratory metabolic simulator includes a catalytic carbon dioxide generator having a first inlet adapted for receiving a fuel and a second inlet adapted for receiving a gas; a breathing simulator; and a controller; wherein an exhaust of the catalytic carbon dioxide generator combines with an exhaust of the breathing simulator; and wherein the controller is configured to vary at least one of the fuel and the gas provided to the catalytic carbon dioxide generator such that the combined exhausts emulate human exhalation.

### CROSS REFERENCE TO RELATED APPLICATIONS

This application claims priority to U.S. Provisional Patent Application No. 61/879,478 entitled “Metabolic Simulator having a Catalytic Engine”, filed Sep. 18, 2013, which is hereby incorporated by reference in its entirety.

### BACKGROUND OF THE INVENTION

1. Field of the Invention

The invention relates generally to metabolic simulators. More specifically, the invention relates to metabolic simulators having a catalytic engine that provides catalytic combustion to a fuel in order to produce carbon dioxide.

2. Description of Related Art

All living organisms with lungs breathe air in order to ventilate their lungs. The human body consumes oxygen (O₂) and generates carbon dioxide (CO₂) in the process of metabolism. The general rule of thumb is 21% of O₂ goes into the lungs and roughly 17% O₂ and 4% CO₂ comes out of the lungs. A breathing simulator is capable of breath by breath control of a simulated ‘patient’. As can be appreciated by those skilled in the art, it would be advantageous to develop an add-on device or system for a respiratory metabolic simulator that can mimic the human metabolism as realistically as possible.

One system for use with an respiratory metabolic simulator to generate CO₂ and to remove or deplete O₂ is a direct methanol fuel cell (hereinafter also referred to as “DMFC”) disclosed in U.S. Patent Publication No. 2012/0060933, entitled “Metabolic Simulator”, filed Sep. 14, 2011, the disclosure of which is incorporated herein by reference. Discussed herein is another system, e.g., a catalytic generator, or catalytic combustion for generating CO₂ and for removing or depleting O₂. Advantages of catalytic combustion include, but are not limited to, rapid availability, ease of implementation in a commercial product, mobility, and optional fuels for different respiratory quotient (hereinafter also referred to as “RQ”) or respiratory exchange ratio (hereinafter also referred to as “RER”). RER is measured at the mouth of a human subject and RQ is the ratio of CO₂ produced and O₂ consumed at a cellular level. Usually, RER equals RQ but, in some cases, such as hyperventilation or intense exercise, estimating the RQ value using RER measurements loses accuracy due to factors that affect the expelled CO₂ levels. The RER value indicates the type of ‘fuel’ that is used by the body. An RER of 0.70 indicates that fat is the predominant fuel source. A value of 0.85 suggests a mix of fat and carbohydrates are the predominant fuel source, and a value between 1.00 and 1.3 indicates that carbohydrates are the predominant fuel source. RER is about 0.8 at rest with a modern diet.

There are several methods to deplete oxygen and produce carbon dioxide with different advantages and disadvantages. In the present discussion, a catalytic carbon dioxide generator was tested and showed controllable O₂ uptake and CO₂ production capabilities.

The advantages of catalytic oxidation over a methanol burner are lower heat production and higher safety. Less heat is produced per ml of CO₂ and there is no flame. A flame can easily be extinguished or start flickering at higher ventilation rates. Unlike a methanol burner it does not matter in what orientation a catalyst is used. Accidentally bumping into a methanol burning system could lead to a dangerous situation.

### SUMMARY OF THE INVENTION

In one preferred but non-limiting embodiment, a respiratory metabolic simulator includes a catalytic carbon dioxide generator having a first inlet adapted for receiving a fuel and a second inlet adapted for receiving a gas; a breathing simulator; and a controller; wherein an exhaust of the catalytic carbon dioxide generator combines with an exhaust of the breathing simulator; and wherein the controller is configured to vary at least one of the fuel and the gas provided to the catalytic carbon dioxide generator such that the combined exhausts emulate human exhalation.

In an alternate but non-limiting embodiment, a respiratory metabolic simulator includes a catalytic carbon dioxide generator having a first inlet adapted for receiving a fuel and a second inlet adapted for receiving a gas; a controller; a breathing simulator in fluid communication with the catalytic carbon dioxide generator; a fuel pump in communication with the controller and adapted to deliver a fuel to the first inlet; a gas pump in communication with the controller and adapted to deliver a gas from the breathing simulator to the second inlet; and a mixing chamber in fluid communication with the breathing simulator and the catalytic carbon dioxide generator; wherein an exhaust of the catalytic carbon dioxide generator mixes with an exhaust of the breathing simulator in the mixing chamber; and wherein the controller is configured to vary at least one of the fuel pump and the gas pump such that the combined exhausts emulate human exhalation.

Also disclosed is a method of delivering carbon dioxide in a simulated respiration system which includes the steps of providing a breathing simulator having an exhaust; providing a gas to a catalytic carbon dioxide generator; providing a fuel to the catalytic carbon dioxide generator; generating an exhaust from the catalytic carbon dioxide generator comprising carbon dioxide; combining the exhaust from the breathing simulator and the catalytic carbon dioxide generator; and controlling at least one of the gas and the fuel supplied to the catalytic carbon dioxide generator via the controller such that the combined exhausts emulate human exhalation.

### BRIEF DESCRIPTION OF THE DRAWING(S)

FIG. 1 is a schematic diagram of the metabolic simulator having a catalytic engine;

FIG. 2 is a schematic diagram of the catalytic carbon dioxide generator;

FIG. 3 is a chart of the fuel depletion rate with different fuel volumes;

FIG. 4 is a chart of the fuel depletion rate with 250 mL of fuel;

FIG. 5 is a chart of fuel flow versus air flow at a 1 molar concentration; and

FIG. 6 is a chart of fuel flow versus air flow at a 4 molar concentration.

### DESCRIPTION OF THE INVENTION

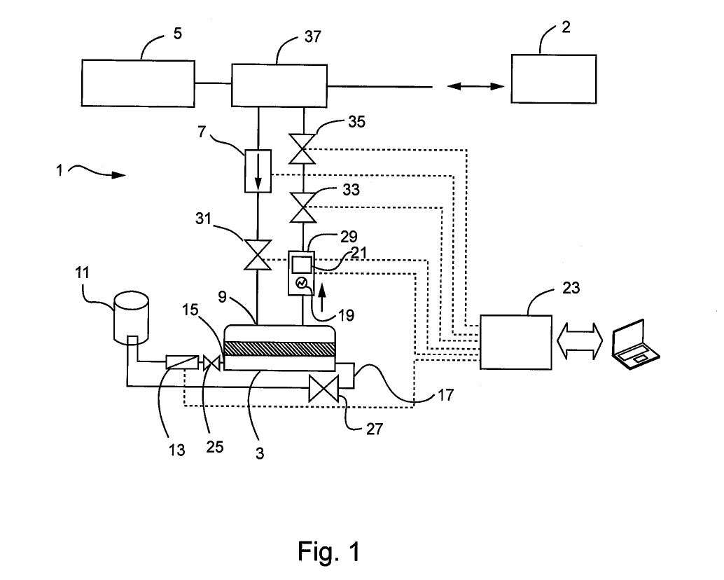

According to the preferred but non-limiting embodiment of FIG. 1, a respiratory metabolic simulator 1 is shown. The respiratory metabolic simulator 1 has a catalytic carbon dioxide generator 3 and can be used as an add-on to a breathing simulator 5. The breathing simulator 5 is preferably a digitally controlled, high fidelity breathing simulator that can reproduce a wide range of ‘patient’ scenarios ranging from neonatal to adult, normal to diseased (asthma, apnea, etc.).

During simulation, the breathing simulator 5 breathes according to the patient scenario set by the user. A gas pump 7 draws air from the breathing circuit and pumps it into the catalytic carbon dioxide generator 3 via the second inlet adapted for receiving a gas 9. The air flow is preferably in the range of 0-2 L/min. The carbon dioxide generator 3 can be any material capable of catalytic combustion to generate CO₂. For example, a “DMFC,” like those made by Giner™, can be used to generate the CO₂. If a DMFC is used, the electricity generated can be used in the system, or burned off in a resistor. At the same moment, fuel, such as formaldehyde or methanol diluted in water, is pumped from a fuel source 11 via a fuel pump 13 to the catalytic carbon dioxide generator 3 via the first inlet adapted for receiving a fuel 15 and recycled back into the fuel source 11 via the closed loop system 17. The fuel is preferably formaldehyde or methanol, but can be any carbon containing compound which is compatible with the carbon dioxide generator 3. In a preferred but non-limiting embodiment, the fuel flow ranges between 0-15 mL/min. After passing through the catalytic carbon dioxide generator 3, the air is cooled and condensed using a condenser 19, and then a polisher 21 oxidizes remaining fuel in the outlet stream. The condenser 19 can be any heat exchanger capable of condensing vapor into a liquid. The condensed water is collected in a water trap. The condition of the gas is then measured by several sensors in communication with a controller 23 before it is pumped back into the breathing circuit. The controller 23 drives the pumps and fan, and reads information from the sensors. The respiratory metabolic simulator is setup as a side stream circuit so that it is invisible to the device that is attached to the breathing simulator 5. To keep volume measurement errors as low as possible, the complete circuit is preferably free of leakage. Various sizes of tubing and connectors can be used to connect the components in the setup. Heated tubing is preferable to prevent condensation in the circuit. The temperature of the heated tubing will vary based on environmental conditions, but should be sufficiently high to prevent condensation. Preferably, the heated tubing is between 19 and 40° C., but could be higher or lower depending on environmental factors. A fuel inlet temperature sensor 25 and a fuel outlet temperature sensor 27 can also be used to monitor the temperature of the catalytic carbon dioxide generator 3 by comparing the temperature of the inlet fuel versus the outlet fuel.

Trace amounts of fuel in the outlet stream can occur when too much fuel and/or an insufficient amount of fresh air (O₂) is supplied to the catalytic carbon dioxide generator 3. In this situation, not enough oxygen molecules are available for complete oxidation of the fuel before it exits the catalyst on the air side.

This incomplete oxidation of methanol makes it harder to predict the volume of CO₂ that is produced since it makes it more difficult to know exactly how much fuel is oxidized. For example, when methanol is used as a fuel, roughly 10 ppm (0.00001%) of the outlet stream may consist of un-oxidized methanol vapor when the catalytic carbon dioxide generator 3 is set to produce 10% of CO₂ and a sufficient amount of O₂ is supplied.

It is also possible to control the amount of CO₂ produced by varying the fuel supply rate within certain limits of air flow rate. When a change in setpoint for CO₂ quantity occurs, both air and fuel flow rates can be adjusted via the controller 23 to ensure that the right amount of CO₂ is produced. Controlling the air and fuel flow rates provides the advantage of supplying the optimal amount of fuel, which would results in less fuel vapor in the outlet air stream.

In order to minimize fuel vapor which escapes into the outlet gas stream, a heated catalytic polisher 21 can be placed in the airstream after the catalytic carbon dioxide generator 3. The catalytic polisher 21 converts residual fuel vapor into carbon dioxide, similar to the carbon dioxide generator 3, and can likewise be any material capable of catalytic combustion, such as a DMFC. As an example, the catalytic polisher 21 may reduce the fuel vapor from a few ppm to ppb. The polisher's performance might decrease when water vapor is present in the gas stream, therefore, a preferred but non-limiting embodiment includes a condenser 19 to minimize water vapor. The air is cooled and condensed using the condenser 19, and the water condensate is captured in a water trap. The polisher 21 and condenser 19 are, together, the fuel removing unit 29.

The catalytic carbon dioxide generator 3 can preferably work with very low fuel flows, such as 1-15 ml/min. Therefore, an accurate low flow gas pump 7 should be implemented to account for varying flow rates. Since different gases have different velocities, a measurement error may increase when the flow meter 31 is not correctly configured. As such, the flow meter 31 can be configured for different gas compositions to minimize errors in flow measurement.

In a preferred but non-limiting embodiment of the invention, precise measurement of temperature and humidity are obtained from the outlet of the catalytic carbon dioxide generator 3 via the temperature and humidity sensor 33 in order to make corrections for measured volume displacement. The measurement of O₂ via a gas composition sensor 35 is implemented in the respiratory metabolic simulator setup to verify the amount of O₂ that is consumed by the catalytic carbon dioxide generator 3. The gas composition sensor 35 can also be used for the continuous measurement of CO₂ and respiratory rate.

The catalytic carbon dioxide generator 3's core temperature can be measured at the fuel outlet via the temperature and humidity sensor 33. The fuel inlet and outlet temperatures can be read from two temperature sensors 25, 27.

The discharge of the carbon dioxide generator unit 3 can be discharged to a user 2 by itself, or it can be mixed with a discharge of the breathing simulator 5 in a mixing chamber 37. Whether the discharge of the carbon dioxide generator unit 3 is mixed with the breathing simulator 5 or not, the preferred but non-limiting embodiment of the present invention is to emulate human exhalation for the end user 2. What is considered “human exhalation” can change depending on factors such as any breathing conditions like asthma or emphysema, as well as the age of the simulated human (i.e., neonatal, child, etc.). Human exhalation can include gas composition (i.e., the ratio of CO₂ to O₂ to N₂), as well as the flow rate of gases discharged to the end user 2.

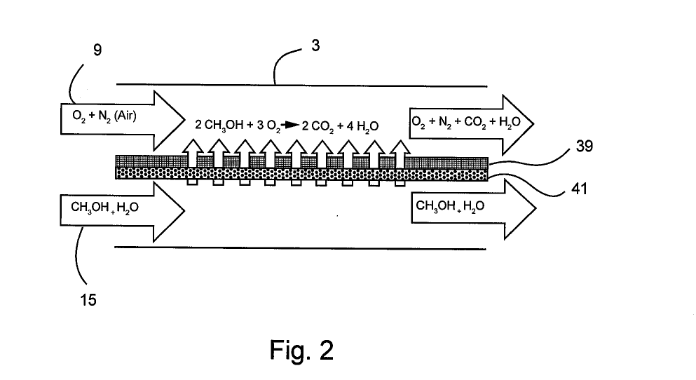

FIG. 2 is a schematic representation of catalytic carbon dioxide generator 3 with ideal oxidation of methanol. The catalytic carbon dioxide generator 3 is a passive CO₂ generating device in that it has no moving parts. The CO₂ is generated by the catalyzed oxidation of fuel (e.g., methanol or formaldehyde) by oxygen in air (or other type of oxygen stream). In a preferred but non-limiting embodiment, the fuel is diluted in distilled or deionized water. The delivery of the fuel to the catalyst 39 can be governed by diffusion through a perm selective film 41.

The methanol permeation rate can be increased with higher methanol concentrations and higher catalytic carbon dioxide generator 3 temperatures. When the ambient temperature around the catalytic carbon dioxide generator 3 is lower, the catalytic carbon dioxide generator 3 temperature is generally lower with higher methanol solution flow rates. The CO₂ is provided in the air (oxygen) outlet stream, along with water and trace amounts of fuel. In addition to altering fuel concentration and catalytic carbon dioxide generator 3 temperature, carbon dioxide generation can also be controlled by using different types of fuel, which will vary the RQ value. For example, using methanol typically yields an RQ of 0.667 and formaldehyde will typically yield an RQ of 1. Different types of fuel can produce higher RQ values.

### Working Examples

To make sure the test results reflected the catalytic carbon dioxide generator's 3 behavior, all of the tests were performed with the polisher disabled. The heated tubing was activated to prevent water condensation in the tubing. The fan speed on the cooler was set at 50% during all tests.

### Example 1

The fuel used in the first example consists of 99.8% methanol diluted in water. The molar concentration in the tests varied between 1 and 4 molar.

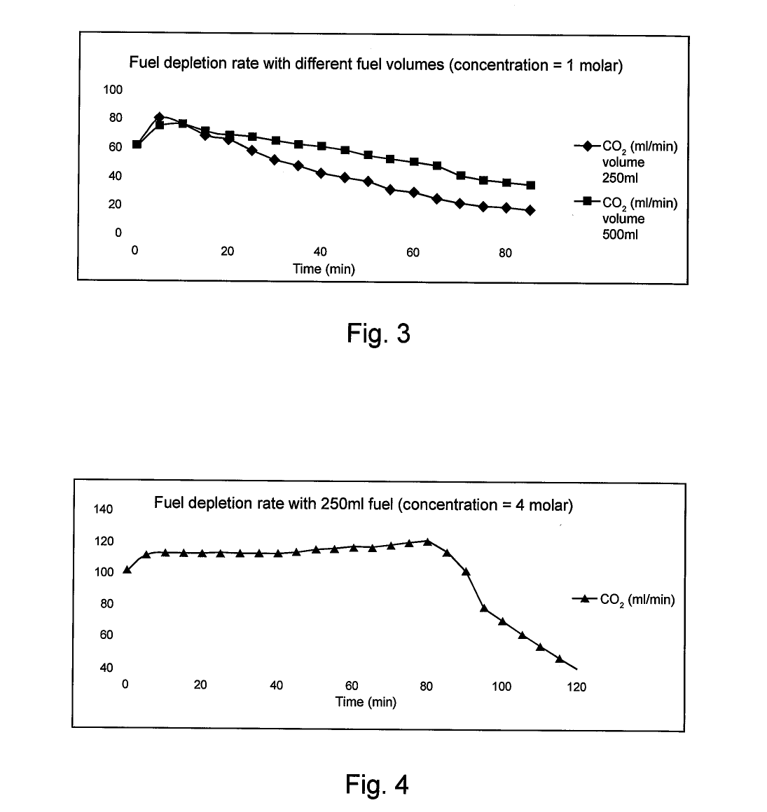

With reference to FIGS. 3 and 4, the methanol was diluted in water and the perm selective film in the catalytic carbon dioxide generator only allowed methanol molecules to pass through to the catalyst, leaving the water in the fuel stream. Since methanol and water are both a clear solution, it is not visible to the user how much methanol is left in the fuel solution. Tests were performed to investigate the speed of fuel depletion with different molarities and volumes. During the first depletion test, the fuel concentration was 1 molar methanol in distilled water. Air and fuel flow speed were kept at a constant level and CO₂ production was measured every 5 minutes. After 10 minutes, the CO₂ production started to drop with a linear gradient. The same test was executed with a volume of 250 mL and a 4 molar fuel concentration. At a 4 molar concentration, the CO₂ production stayed constant at approximately 112 mL/min for 80 minutes and then started to drop. At this higher fuel concentration, the CO₂ production does not drop right away due to lack of O₂ molecules that are available to the catalytic carbon dioxide generator. For every three O₂ molecules, the catalytic carbon dioxide generator needs two methanol molecules and will produce two CO₂ molecules. Thus, when there are not enough O₂ molecules available, the catalytic carbon dioxide generator will produce a limited constant amount of CO₂ until the methanol concentration is less than the O₂ concentration.

This depletion of methanol influences the CO₂ production, but when the fuel is not recycled, a lot of fuel is wasted. A methanol sensor can be implemented in the fuel tank to keep track of the methanol concentration in the fuel. With this feedback, additional methanol could be diluted with the fuel to keep the fuel concentration within its limits.

### Example 2

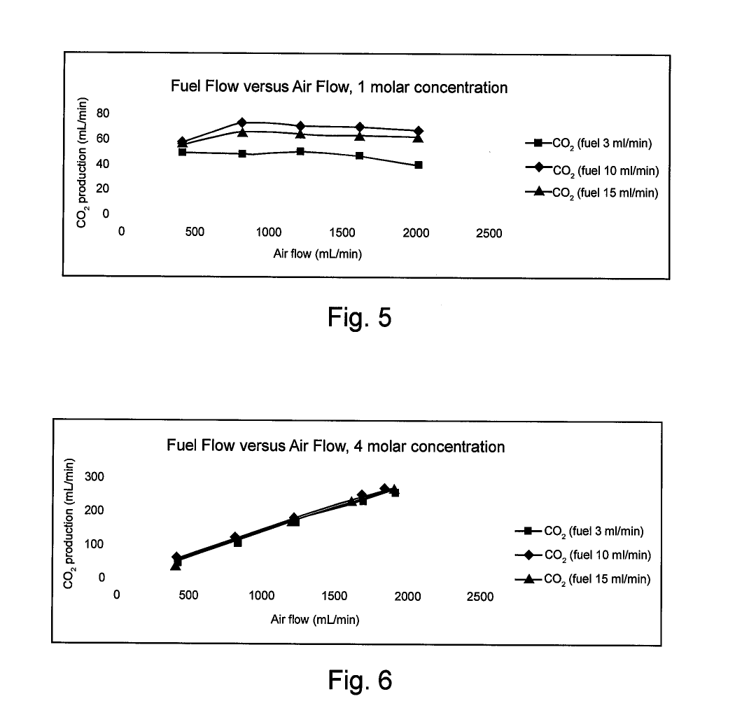

With reference to FIGS. 5 and 6, theoretically, the \dot{V}CO₂ produced by the catalytic carbon dioxide generator should be controllable by getting the air and fuel flow at a correct setpoint. When the fuel flow is lowered, less fuel molecules are fed to the catalyst, thus fewer molecules will be oxidized and less CO₂ will be produced. As such, the catalytic carbon dioxide generator was run at different air and fuel flow rates. During these tests, the fuel was not recycled. The data collected in FIGS. 5 and 6 shows a difference in \dot{V}CO₂ due to fuel flow variation. At 4 molar the fuel flow did not influence \dot{V}CO₂. This is caused by the high concentration of methanol. Even at lower fuel speeds, there were a lot more molecules of methanol available than there were molecules of O₂ present in the airstream that are needed for the oxidation of methanol.

The above discussion demonstrates that it is possible to control the flow rate or stream of CO₂ generated by a catalytic carbon dioxide generator for use in a metabolic simulator by varying the air and fuel flow rates of the catalytic carbon dioxide generator.

Further, the invention is not limited to the non-limiting embodiments of the invention discussed above, and the scope of the invention is only limited by the scope of the following claims.

1. A respiratory metabolic simulator comprising:
a catalytic carbon dioxide generator having a first inlet adapted for receiving a fuel and a second inlet adapted for receiving a gas;
a breathing simulator; and
a controller;
wherein an exhaust of the catalytic carbon dioxide generator combines with an exhaust of the breathing simulator; and
wherein the controller is configured to vary at least one of the fuel and the gas provided to the catalytic carbon dioxide generator such that the combined exhausts emulate human exhalation.

2. The respiratory metabolic simulator of claim 1, wherein the catalytic carbon dioxide generator further comprises a catalyst and a perm selective film.

3. The respiratory metabolic simulator of claim 1, further comprising a fuel source which supplies the fuel to the first inlet of the catalytic carbon dioxide generator, and wherein the controller controls the flow of fuel to the first inlet of the catalytic carbon dioxide generator.

4. The respiratory metabolic simulator of claim 3, wherein the fuel is methanol.

5. The respiratory metabolic simulator of claim 3, wherein the fuel is formaldehyde.

6. The respiratory metabolic simulator of claim 3, wherein unused fuel from the catalytic carbon dioxide generator is recycled to the fuel source in a closed loop system.

7. The respiratory metabolic simulator of claim 6, further comprising a fuel concentration sensor in the closed loop system, wherein the fuel source is maintained at a substantially constant concentration by the addition of new fuel.

8. The respiratory metabolic simulator of claim 1, further comprising a fuel removing unit in fluid communication with the catalytic carbon dioxide generator and adapted to receive the exhaust from the catalytic carbon dioxide generator.

9. The respiratory metabolic simulator of claim 7, wherein the fuel removing unit comprises a condenser in fluid communication with the catalytic carbon dioxide generator, and a polisher in fluid communication with the condenser.

10. A respiratory metabolic simulator comprising:
a catalytic carbon dioxide generator having a first inlet adapted for receiving a fuel and a second inlet adapted for receiving a gas;
a controller;
a breathing simulator in fluid communication with the catalytic carbon dioxide generator;
a fuel pump in communication with the controller and adapted to deliver a fuel to the first inlet;
a gas pump in communication with the controller and adapted to deliver a gas from the breathing simulator to the second inlet; and
a mixing chamber in fluid communication with the breathing simulator and the catalytic carbon dioxide generator;
wherein an exhaust of the catalytic carbon dioxide generator mixes with an exhaust of the breathing simulator in the mixing chamber; and
wherein the controller is configured to vary at least one of the fuel pump and the gas pump such that the combined exhausts emulate human exhalation.

11. The respiratory metabolic simulator of claim 10, further comprising a fuel removing unit in fluid communication with the catalytic carbon dioxide generator and adapted to receive the exhaust from the catalytic carbon dioxide generator.

12. The respiratory metabolic simulator of claim 11, further comprising a gas composition sensor at an outlet of the fuel removal unit.

13. The respiratory metabolic simulator of claim 12, further comprising a temperature and humidity sensor at an outlet of the fuel removal unit.

14. The respiratory metabolic simulator of claim 13, further comprising a flow and pressure sensor between the gas pump and the second inlet of the catalytic carbon dioxide generator.

15. The respiratory metabolic simulator of claim 14, wherein at least one of the gas composition sensor, the temperature and humidity sensor, and the flow and pressure sensor provides data and is in communication with the controller, and wherein the controller uses the data to control at least one of the gas pump and fuel pump such that the combined exhausts of the catalytic carbon dioxide generator and the breathing simulator emulate human exhalation.

16. A method of delivering carbon dioxide in a simulated respiration system comprising the steps of:
providing a breathing simulator having an exhaust;
providing a gas to a catalytic carbon dioxide generator;
providing a fuel to the catalytic carbon dioxide generator;
generating an exhaust from the catalytic carbon dioxide generator comprising carbon dioxide;
combining the exhaust from the breathing simulator and the catalytic carbon dioxide generator; and
controlling at least one of the gas and the fuel supplied to the catalytic carbon dioxide generator via the controller such that the combined exhausts emulate human exhalation.

17. The method of delivering carbon dioxide in a simulated respiration system according to claim 16, further comprising the step of removing unused fuel from the catalytic carbon dioxide generator exhaust.

18. The method of delivering carbon dioxide in a simulated respiration system according to claim 16, wherein the fuel is methanol.

19. The method of delivering carbon dioxide in a simulated respiration system according to claim 16, wherein the fuel is formaldehyde.

20. The method of delivering carbon dioxide in a simulated respiration system according to claim 16, wherein controlling at least one of the gas and the fuel supplied to the catalytic carbon dioxide generator via the controller further comprises controlling at least one of the gas and the fuel based on data obtained from at least one of a gas composition sensor, a temperature and humidity sensor, and a flow and pressure sensor.
